(19) United States
(12) Patent Application Publication
(10) Pub. No.: US 2009/0022477 A1
(43) Pub. Date: Jan. 22, 2009

(54) RECORDING BROADCAST DIGITAL CONTENT IN A PRIVACY PRESERVING WAY

(75) Inventors: Milan Petkovic, Eindhoven (NL); Hong Li, Kermisberg (NL); Albert Maria Arnold Rijckaert, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N,V,, Eindhoven (NL)

(21) Appl. No.: 12/280,724

(22) PCT Filed: Feb. 23, 2007
(86) PCT No.: PCT/IB07/50578

§ 371 Date: Aug. 26, 2008

(30) Foreign Application Priority Data
Mar. 3, 2006 (EP) 06300197.8

(51) Int. Cl. H04N 5/91

(52) U.S. Cl. 386/83; 725/58; 386/E05.001

(57) ABSTRACT

A method and device for making pre-scheduled recordings of broadcasted content in a recording device, comprising receiving (step S2) a scheduled recording request with a privacy setting from an authenticated user, determining (step S3) that said requested scheduled recording conflicts with a previously scheduled recording, communicating (step S5) a request to a remote receiver to record content according to the scheduled recording that is found to be in conflict with previously scheduled recordings, receiving (step S6) said recorded content from said remote receiver, storing said recorded content, and controlling access to the stored content based on said privacy setting. According to the invention, a network of recording devices are used to avoid conflicts. Instead of dealing with increased security and privacy of recording schedules when a conflict arises on a device, the present invention aims at making more recording resources available, thus reducing the risk for a conflict.

The present invention relates to a method for recording broadcast digital content on a recording device in a privacy preserving way, i.e. without making the recording (or even its existence) known to other users of the system. More specifically, the present invention relates to a method and a device for making pre-scheduled recordings of broadcasted content in a recording device, wherein a scheduled recording request is received with a privacy setting from an authenticated user, and it is determined whether the requested scheduled recording conflicts with a previously scheduled recording.

Recent developments in personalized entertainment give each user the possibility to record or collect his favorite content, to maintain his/her personal content collection, and to entertain in his own style. Consumer electronic devices therefore need to provide a multi-personalized entertainment environment for family members and friends.

Such an environment raises a number of multi-user issues, which are related to properly managing the shared devices, storage, resources and ease-of-use personal user interaction interface. Furthermore, it raises some issues on privacy, such as: privacy protection between users and against the rest of the world, owner-controlled content sharing mechanism, private access to content from anywhere etc. One of the important issues is the problem of privacy preserving scheduling and recording of broadcast content (e.g. television) using connected devices that have privacy enhancing functionality. Providing multiple users with recording capabilities is described in U.S. Pat. No. 6,564,005.

Typically, such a system can include means for providing auto-recording functionality, i.e. allowing a user to request recording of content in advance. One example is the preset recording of broadcasted TV content. A recording device (e.g. a storage device connected to a TV tuner) typically has an auto-recording schedule management system to ensure there are no conflicts between recordings (such conflicts arise e.g. when the number of simultaneous recordings exceed the number of available tuners). However, such management systems will typically expose details of the scheduled recordings, thus making preservation of privacy impossible. By completely “hiding” a scheduled recording, another user cannot receive adequate feedback in a situation where a new recording conflicts with a previously scheduled (private) recording.

A simple way to ensure full privacy is to assign the recording the lowest possible priority, such that any other activity may override the private recording. This will ensure that the private recording does not influence any other recordings, and it will thus not be exposed. On the other hand, the private recording runs a significant risk of not being effected, due to its low priority.

Another alternative is to partially hide the private recording, i.e. to make all details of the recording unavailable, but to inform a user when a conflict arises. The user could then be given the option to abandon or override the previously scheduled recording. However, this will still reveal that a recording has been scheduled, and another user can most likely monitor the system (e.g. the tuner) to find out what program is actually recorded.

It is therefore preferred to enable recording of content in a privacy preserving way. More specifically, it would be preferred to handle conflicts between scheduled recordings in a resource scarce system, without revealing information about the recordings.

A first aspect of the present invention relates to a method for making pre-scheduled recordings of broadcasted content in a recording device, comprising receiving a scheduled recording request with a privacy setting from an authenticated user, determining that the requested scheduled recording conflicts with a previously scheduled recording, communicating a request to at least one remote receiver to record content according to the scheduled recording that is found to be in conflict with previously scheduled recordings, receiving the recorded content from the at least one recording device, storing the recorded content, and controlling access to the stored content based on the privacy setting.

According to this method, a network of recording devices are used to avoid conflicts. Instead of dealing with increased security and privacy of recording schedules when a conflict arises on a device, the present invention aims at making more recording resources available, thus reducing the risk for a conflict.

According to one embodiment, the recorded content is stored intermediately on the remote receiver, before being received by the recording device. This increases flexibility, but requires that the privacy of the content is maintained, i.e. that the device is privacy compliant, and that access to the content is restricted to the user that requested the recording. This can be resolved by letting the remote receiver initially assume ownership of the content, and prevent others from accessing this content. This ownership is then preferably transferred to the recording device when the recorded content is received, and finally transferred to the user who requested the recording when this user authenticates on the recording device the next time. Alternatively, the ownership is transferred directly from the remote receiver to the user, when the user authenticates on the any recording device connected to the remote receiver.

According to another embodiment, the content is streamed over a secure channel from the remote receiver to the recording device without being intermediately stored. This removes some of the requirements of security on the remote receiver, but instead requires that the remote receiver and the recording device are connected throughout the recording. In this case, the recording device can initially assume ownership of the content. The ownership can then be transferred from the recording device to the user when the user authenticates on the recording device.

The recorded content can be stored on a secure storage, or be access controlled by a digital rights management system.

According to a further embodiment, the method includes receiving a message from said remote receiver indicating that a conflict has occurred with said recording request, and in response to said message, communicating a request to an additional remote receiver to record said content. This means that the recording device attempts to ensure that the recording is performed even if a conflict occurs at the device that has been requested to perform the recording.

Alternatively, the method includes receiving a message from said remote receiver indicating that said recording request has been relayed to an additional remote receiver, and receiving said content from said additional remote receiver. In this case, it is the remote receiver that will handle the relay in order to avoid a conflict and ensure that the recording is performed.

In a situation where a conflict occurs during recording, it is possible that the content will be partially recorded at different recording devices.

As second aspect of the present invention relates to a device for making pre-scheduled recordings of broadcasted content, comprising a recording unit for receiving broadcasted content, and storing it on a storage, input means for allowing a user to schedule a recording and privacy setting for the recording, a control unit being adapted to determine that the scheduled recording conflicts with a previously scheduled recording, means for communicating a request to at least one remote receiver to record content according to the scheduled recording that is found to be in conflict with previously scheduled recordings, means for receiving the recorded content from the at least one recording device, and storing it on the storage medium, with access rights based on the privacy setting.

The advantages of the system are similar to the ones described with reference to the first aspect of the present invention.

A third aspect of the present invention relates to a computer program product, comprising computer code portions for performing the steps of the method according to the first aspect of the invention.

These and other aspects of the present invention will now be described in more detail, with reference to the appended drawings showing a currently preferred embodiment of the invention.

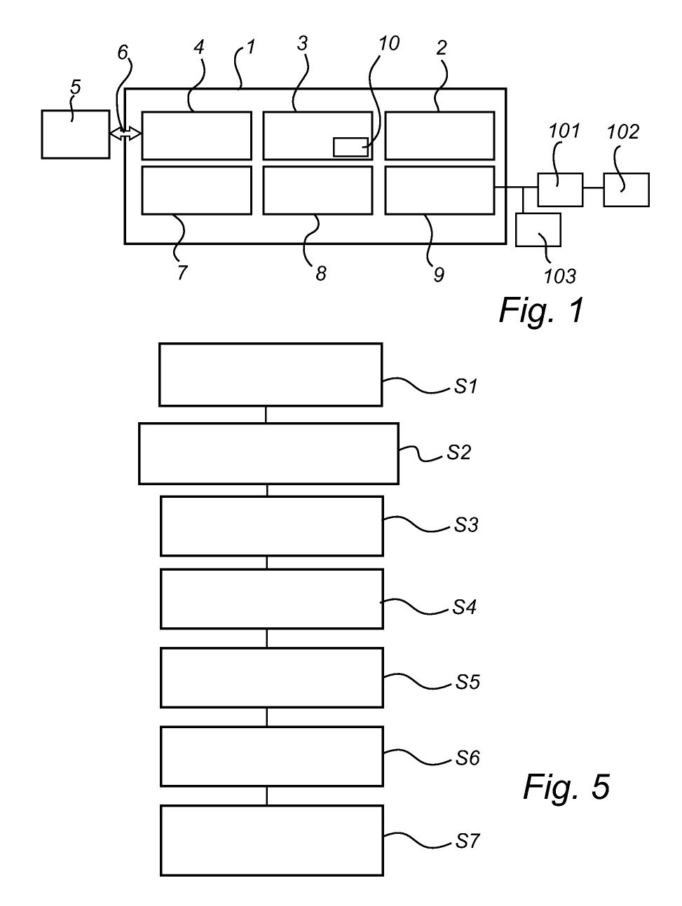

FIG. 1 is a schematic block diagram of a recording device according to a first embodiment of the invention.

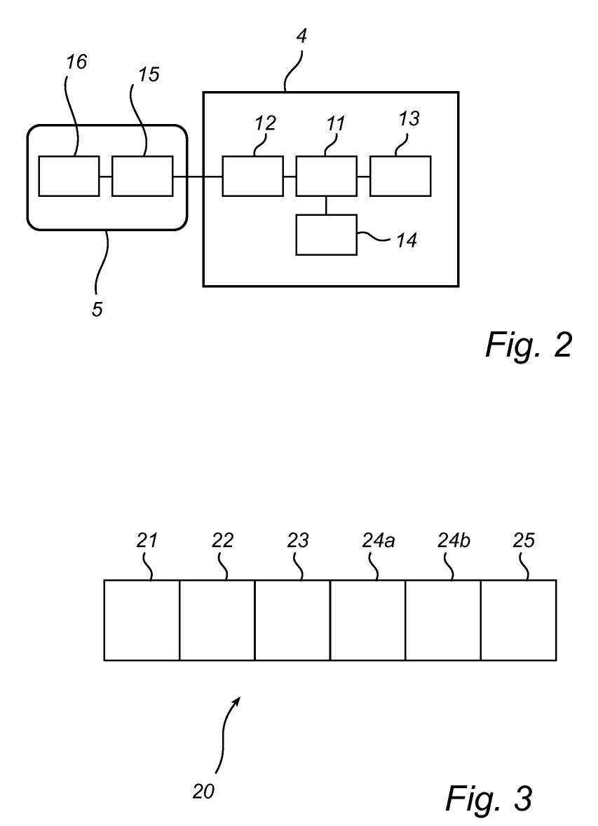

FIG. 2 shows the physical key and secure subsystem in FIG. 1 in more detail.

FIG. 3 shows an example of an access message.

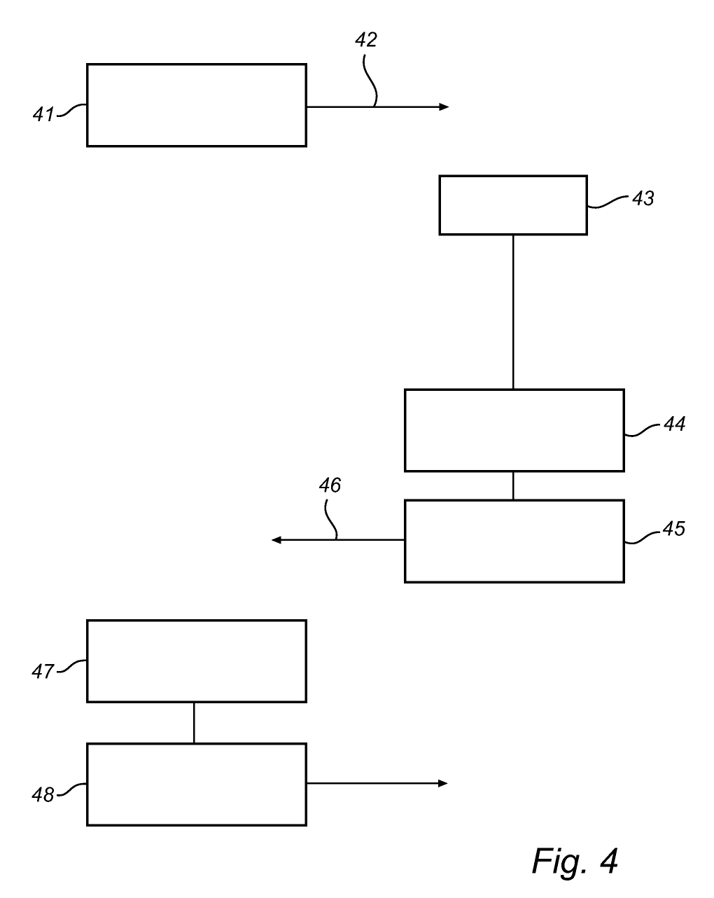

FIG. 4 is a flow chart illustrating an example of a process for ownership transfer suitable for implementation in an embodiment of the present invention.

FIG. 5 is a flow chart of a method according to a second embodiment of the invention.

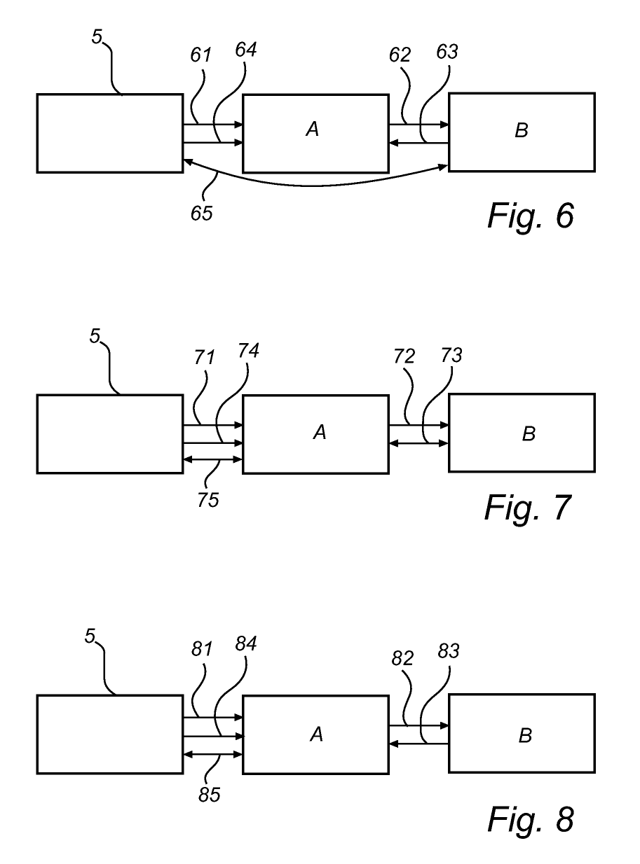

FIGS. 6-8 show three examples of how ownership is transferred to the user that requested the recording.

Various embodiment of the present invention will here be described with reference to a specific approach to handle privacy and access rights (physical key, secure subsystem, asset key, access message, etc). It should be noted that the present invention by no means is limited to this approach.

FIG. 1 shows a recording device 1 according to an embodiment of the present invention. The recording device is provided with a receiver 2 for receiving broadcasted content, e.g. a TV tuner, and a recording unit 3 for storing broadcasted content on a recording medium 10. The recording device is controlled by a secure subsystem 4, to which a user can be authenticated. In the present example, the user is authenticated using a physical key 5, which is connected to the secure subsystem over a secure channel 6. The recording device 1 further includes a user interface 7 to allow a user (after he has authenticated himself using his physical key) to schedule private recordings. For this purpose, the user can enter a recording schedule, defining what content should be recorded, and a privacy level for the recorded content.

The secure subsystem ensures that recorded content which has been defined as private is only accessible to the user who scheduled it and possibly to other users who have been granted sharing rights from this user. This is here achieved by implementing a suitable Digital Rights Management system.

Typically, the user is not on-line (i.e. his physical key is not present) at the time when the recording takes place. The system must therefore be able to write the content to a recording file and protect it. Two options exist:
1) When scheduling the recording, the user creates an empty recording file and grants the system the rights to write data to this file. The user is the owner of the file. In this case the system only needs to know the filename, recording channel and time, so the privacy of the request creator is maximally ensured. However, this solution is only suitable when the user knows how many recordings will be made. This might not be the case, e.g. in case of recording a series.
2) The recording device autonomously creates a new recording file each time a recording is started, and assumes ownership of this file. The device immediately grants access rights to the request creator, to enable time-shifting functionality (i.e. viewing the content while it is being recorded, possibly with a time delay). When the recording is finished the ownership is transferred to the request creator, and gives up all its own rights.

In the presently described embodiments, the second alternative will be used, and the protocol for transfer of ownership will be described in more detail below.

Returning to FIG. 1, the recording device 1 is further provided with a scheduling manager 8, handling all scheduled recordings. This manager is adapted to detect any conflict, i.e. when recordings of different sources (e.g. different TV stations) are scheduled for the same time. The recording device is further provided with an interface 9 for communicating with other recording devices 101, 102, 103, etc, together forming a network of recording devices. Over the network, the secure subsystems in respective recording device can communicate with each other in a secure way.

The secure subsystem and the private key are shown in more detail in FIG. 2.

The secure subsystem 4 has a cryptographic processor 11 for content encryption and decryption, a secure interface 12 to receive a physical key, an interface 13 to the recording unit (used for e.g. content streaming), and a memory 14, such as a RAM.

The physical key 5 has a message processor 15, and a memory 16, such as a flash memory or RAM memory, including a secure memory and a main memory. In the memory a unique private-public key pair is stored. The public key (PK) of a user is of course public, while the private key (SK, secret key) is stored in the secure portion of the memory 16 and is never exposed outside the physical key 5 (compliance of the physical key). The secure portion of the memory 16 is only accessible by the processor 15 for processing key-pairs and access message. A non-secure section of memory 16 is not necessary for the major physical key functions (i.e. authentication, access message processing, etc.), however it is useful to have more space for data, e.g. the access messages, the public keys of others, the usage history and even application data and content.

According to this embodiment, content is protected in a two-layer protection model: each protected content item is encrypted with a symmetric cipher, i.e. using an encryption key or asset key. The asset key is encrypted and stored in access messages. An access message contains an encryption key (asset key) of an encrypted content (an asset) and the access rights for an authorized user, which determine among others whether the secure subsystem 4 should decrypt the asset for playback. The access messages are created by message processor 15 and can be stored in the memory 16, the memory 14, or any other storage, depending on the purpose of the access message.

An access message is digitally signed using the private key of the content owner, thereby ensuring message integrity, i.e. only the owner can create the message. In this way, only the owner can check and modify the rights that he has granted to a user. Other users use an owner's public key to share data with him through an access message which contains an asset key and rights data encrypted with the public key. The owner can also revoke sharing rights and transfer the ownership using the physical key. The secure portion of the memory 14 of the secure subsystem 4 stores a device key-pair (corresponding to the personal key-pair in the physical key), which is unique to this device. The device key-pair is used for device authentication, setting up the channel 6, and for functions like scheduled private recording when the personal physical key is not present.

The secure subsystem 4 and the physical key 5 are used to secure the two-layer protection model. The private key 5 is connected to the interface 12 and a secure channel 6 is initialized by the processors 15 and 11, using the personal key-pair and the device key-pair. The secure subsystem 4 can encrypt or decrypt content from the recording unit using an asset key received from the physical key 5 via the secure channel 6. When a user wants to access his private content through a terminal, it requires the user's Physical key and a secure subsystem to decrypt his access message and the content.

The personal physical key 5 needs limited processing power for messages and limited interface throughput to the secure subsystem. The secure subsystem 4 can be integrated in the recording device or in other digital rendering devices. It can also be a portable plug-in device for legacy devices. It needs a high bandwidth cryptographic processor and interface for AV content. The individual physical key 5 is a tamper-resistant device. It may be embedded in a mobile device, e.g. a key-ring MP3 player or a mobile phone. It can also be a smart card device, or for example a Thumbdrive Touch, that combines biometric technologies to offer a single portable secure storage medium (it prevents unauthorized usage of the user's physical and therefore also the private key). The physical key 5 is not only a user identity for authentication; it is a private rights manager for a person to handle his content on the server 1.

In order to protect a plaintext content (e.g. a recorded TV show or a home video) as private content, a user plugs in his physical key to authenticate to the recording device and opens his/her private environment of the storage 10, and stores the content file in his private domain. An owner can publish private content by decrypting the content and storing it in plaintext. Using the owner's physical key 5, the recording device 1 will ask the owner to complete the authentication procedure again (e.g. using password or bio-matrix), before it starts publishing the content. After publishing, the server cleans up the old access messages and announces the content to other users. In his private environment an owner can grant sharing rights of a content file to other users by selecting a user or a group of users and to specify access rights to them.

An example of an access message 20 is shown in FIG. 3, and comprises a message identifier 21, a user ID block 22, an owner ID block 23, two asset blocks 24a, 24b, and a signature block 25. Each block is 256 bytes, which is large enough for 2048 bits encryption. One message is created for one user to access one asset (content).

The user ID block 22 and the owner ID block 23 contains the user's public key and the owner's public key. They can be stored as plaintext, as they are public information in the environment. Alternatively, the whole access message can be encrypted, one which will be kept by the owner with his public key while another one for a user with the user's public key. These two messages should be linked together, which requires an extra index information (a table with message identifiers, public keys, and asset IDs) which will help the system to operate in an efficient way. To avoid privacy problems such index information should be divided and distributed among user physical keys.

The two asset blocks 24a, 24b contain identical information about an asset: the asset ID pointing to the content file, the asset key used for asset encryption, and the asset rights granted to the user. One block is encrypted with the user's public key, and is thus only readable by the user with his physical key (because the private key of the key-pair, which is necessary to decrypt the block, is inside the physical key). The other block is encrypted with the owner's public key. This block is required when the owner wants to change the message (e.g. the access rights) to the user.

The signature block 25 is required to ensure that no one else can misuse the access message (e.g. fake the ownership or to do anything to the content which is not authorized by the owner). The signature block contains a hashing of the other four blocks, including the encrypted asset blocks, created by the physical key of the owner. The hashing ensures the integrity of every bit in the four blocks. The signature block is then encrypted by the owner's private key: this ensures that only the owner's physical key can create this signature. Any physical key can verify the owner of the message by decrypting the signature block using the owner's public key and comparing the hashing in the signature and the one created by the user's physical key.

The owner uses the same access message mechanism to access his content. In this case, the message has full access rights in the asset block and the user ID block and owner ID block are identical.

Transfer of ownership between two entities (e.g. between device B and device A, or between device A and an authenticated user) can be effected using the protocol illustrated in FIG. 4 and table 1.

TABLE 1

| | |
|---|---|
| Step 41 | Create special access message |
| Step 43 | Check offer |
| Step 44 | Create ownership access message |
| Step 45 | Create clean-up access message |
| Step 47 | Remove old access message |
| Step 48 | Send confirmation message |

First, in step 41, the current owner (first entity, e.g. device B) creates a special access message with an ‘Ownership takeover’ and sends (arrow 42) this access message to the intended new owner (second entity, e.g. device A or a user). When the secure environment of the receiving entity (e.g. secure subsystem or physical key) receives the special access message, the entity's secure environment checks the ownership-transfer offer (step 43). For example, the owner can send a key certificate for the public key to enable such check. Then, in step 44, the new owner's secure environment (e.g. secure subsystem or physical key) creates a new ownership access message using the special access message. The new owner (second user) preferably changes the asset key and re-encrypts the content to ensure a full ownership takeover.

In the illustrated example, the new owner (e.g. device A) in step 45 creates a clean-up message that is sent to the old owner (arrow 46). The old owner (e.g. device B) removes any ownership access message in step 47, and sends a confirmation (step 48) to the new owner. In this way, ownership is transferred in a secure way.

Use of the recording device in FIG. 1 will now be described with reference to FIG. 5 and table 2.

TABLE 2

| | |
|---|---|
| Step S1 | Authenticate |
| Step S2 | Enter recording schedule and privacy |
| | settings |
| Step S3 | Detect conflict |
| Step S4 | Find available device |
| Step S5 | Schedule recording on this device |
| Step S6 | Receive recording |
| Step S7 | User assumes ownership |

First, a user authenticates to the recording device 1 using his private key (step S1), and enters a requested recording schedule and privacy setting (step S2). As described above, a private recording should have the lowest possible priority, in order not to expose its existence to other users.

The scheduling manager 8 then (step S3) detects any conflict between this requested recording and previously scheduled recordings (having various degrees of privacy). When the scheduling manager detects a conflict (either immediately when the request is entered, or at a later pointing time), the secure subsystem 4 in step S4 via the interface 9 contacts the secure subsystems of other connected recording devices 101, 102, . . . , to investigate if any one of the recording devices can effect the recording. If such an available recording device 101 is found, the recording is scheduled with the scheduling manager of this device 101 (step S5).

The scheduled recording is received and stored by the recording device 1 (step S6), either during recording, by streaming it over a secure channel, or after the recording has been completed. In the first case, the devices 1 and 101 must be connected throughout the recording. In the latter case, the content can be received as soon as the two devices are connected to the network simultaneously.

Finally, the user gains access to the content and assumes ownership of the content the next time he/she authenticates to the recording device 1 (step S7). In order to preserve privacy of the content, it is important to provide a secure handling of content ownership, from the device that creates the recording (101 or 1) to the user (i.e. the physical key). Some examples of how this can be accomplished will be given below.

It is possible that a conflict later occurs at the device that has scheduled the recording. This device can then contact the requesting device and cancel the recording, in which case the requesting device can attempt to find another available recording device to schedule the recording. Alternatively, the device that has accepted to schedule the recording may itself attempt to find another available recording device. If successful, it informs the original device of the transfer. In this way the probability for canceling the scheduled private recording is considerably smaller than in the case of a standalone device, even when it has the smallest recording priority (completely hidden request for private recording).

Yet another situation is that a conflict occurs on the recording device 1 during the recording. In this case, although partial content has been recorded on the device, the device can use the above procedure to ask another device 101 to record the rest of the content as the next part (e.g. as part 2 or part 3) of the recording. In order to avoid a gap, the device may continue recording for a few seconds, before it switches to recording the source (e.g. TV station) that conflicts the private scheduled recording.

The other device 101 records the rest of the content using the part number in the request with the same method described above. In the case that a conflict occurs also in device 101, a request can be sent to yet another free device 102 with a new part number (e.g. 3) next to its own part number, etc.

After a completed recording, performed on several different devices, the authenticated user (his physical key) can assume ownership of each recorded part using the transfer of ownership protocol described above. The user can choose to let a device combine the parts into one item, or group them with a list. The content can then be played as a whole. In the case no available device can be found for completing the recording, the private recording request and the partial recorded content can be cancelled, or be stored for a completion later with the next broadcasting of the same content.

Alternatively, of course, the recording device that has a conflict could continue recording and use an available recording device to resolve the request that created the conflict.

As mentioned, ownership of recorded content will have to be transferred from the device that creates the content (i.e. stores the recording) to the user that requested the recording (i.e. his physical key 5). This process will be described in the following, where use of the protocol described above is assumed. Of course, any other ownership transfer protocol with satisfactory security may be used.

According to a first embodiment, a direct transfer of ownership is effected between the device that in fact recorded the content and the user who requested recording (using his physical key).

With reference to FIG. 6, a user (with his physical key 5) authenticates with a device A (arrow 61) and requests a private recording. Device A has a conflict situation, and finds a networked device B that can do the recording. Device A sends a request (arrow 62) comprising the user ID (the public key of the person who requests this private recording), its device ID, details about program (including channel, title, ID from EPG, etc.), time (start time and duration) as well as privacy level of the request (e.g. completely hidden). Device B records the content and assumes ownership of this content. It then sends a confirmation message back to device A (arrow 63). The next time the user authenticates to device A (arrow 64), (or immediately, if the user is still on-line (authenticated)) device B is prompted and the transfer of ownership protocol takes place between the user (his physical key 5) and device B (arrow 65).

A variant of this embodiment is to let device B broadcast the confirmation message to all networked devices. Thereby the transfer of ownership can take place when the user authenticates to any of these devices. Yet another variant is that the user in his scheduling request specifies from which devices he wants to resume ownership of recorded content. Such a procedure should of course be available also when the original device is actually used to make the recording.

A drawback with transferring ownership directly is that the transfer can only take place when device B is available (on-line).

In a second embodiment, illustrated in FIG. 7, the transfer of ownership is effected between device A and B, and then to the user (physical key 5). The initial process is identical to that in FIG. 6 (arrows 71 and 72 corresponding to arrows 61 and 62), and the device B again records and assumes ownership of the content. After completion of the recording, however, device B contacts device A and immediately transfers the ownership to device A (arrow 73). If device A is not online, the transfer will take place the next time devices A and B are online simultaneously. The next time the user authenticates to device A (arrow 74), (or immediately, if the user is still on-line (authenticated)) the transfer of ownership protocol takes place between the user (his physical key 5) and device A (arrow 75).

In a variant of this embodiment, device B can transfer the ownership to a set of devices (e.g. as defined by the user in the request for private program recording), so that he can assume the ownership using any of those defined devices.

This second embodiment is more flexible, and allows both devices to be offline from time to time.

In a third embodiment, shown in FIG. 8, the initial process is again identical to that in FIG. 6 (arrows 81 and 82 corresponding to arrows 61 and 62). This time, however, the device B never assumes ownership of the content. Instead, device B is used only as a tuner, and the content is streamed to device A over a secure channel (between their respective secure subsystems) (arrow 83), and device A records and assumes ownership of the content. The ownership can then be transferred to the user (his physical key 5) when he authenticates to device A (arrows 84 and 85) just like in the second embodiment.

This solution requires that both devices are on-line during the whole process of recording, and in addition device A (which is occupied with performing the conflicting recording) must be able to handle storage of multiple streams.

The described functionality of the herein discussed embodiments can be implemented by suitable software in the recording device and/or any personal security device such as a physical key. However, it should be noted that parts of the functionality instead, or in combination, can be implemented as hardware, e.g. as dedicated circuits in the physical key.

The person skilled in the art realizes that the present invention by no means is limited to the preferred embodiments described above. On the contrary, many modifications and variations are possible within the scope of the appended claims. For example, other protocols may be used to effect the transfer of ownership between the creator of a recorded content and the user who requested the recording.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa. When data is being referred to as audiovisual data, it can represent audio only, video only or still pictures only or a combination thereof, unless specifically indicated otherwise in the description of the embodiments.

Furthermore, the invention may also be embodied with less components than provided in the embodiments described here, wherein one component carries out multiple functions. Just as well may the invention be embodied using more elements than depicted in FIG. 1, wherein functions carried out by one component in the embodiment provided are distributed over multiple components.

It is stipulated that the reference signs in the claims do not limit the scope of the claims, but are merely inserted to enhance the legibility of the claims.

1. A method for making pre-scheduled recordings of broadcasted content in a recording device, comprising:
receiving (step S2) a scheduled recording request with a privacy setting from an authenticated user,
determining (step S3) that said requested scheduled recording conflicts with a previously scheduled recording, further comprising:
communicating (step S5) a request to a remote receiver to record content according to the scheduled recording that is found to be in conflict with previously scheduled recordings,
receiving (step S6) said recorded content from said remote receiver,
storing said recorded content, and controlling access to the stored content based on said privacy setting.

2. The method according to claim 1, wherein said recorded content is stored intermediately on said remote receiver, before being received by said recording device.

3. The method according to claim 2, wherein the owner of said recorded content is initially the remote receiver.

4. The method according to claim 3, wherein content ownership is transferred from said remote receiver to said recording device when said content is received by said recording device.

5. The method according to claim 4, wherein content ownership is transferred from said recording device to said user when said user authenticates on said recording device.

6. The method according to claim 3, wherein content ownership is transferred from said remote receiver to said user when said user authenticates on any recording device connected to remote receiver.

7. The method according to claim 1, wherein said content is streamed on a secure channel to said recording device without being intermediately stored.

8. The method according to claim 7, wherein the owner of said recorded content is initially the recording device.

9. The method according to claim 8, wherein content ownership is transferred from said recording device to said user when said user authenticates on said recording device.

10. The method according to claim 1, further comprising:
receiving a message from said remote receiver indicating that a conflict has occurred with said recording request, and,
in response to said message, communicating a request to an additional remote receiver to record said content.

11. The method according to claim 1, further comprising:
receiving a message from said remote receiver indication that said recording request has been relayed to an additional remote receiver, and
receiving said content from said additional remote receiver.

12. The method according to claim 10, wherein said content is partially recorded on said remote receiver, partially recorded on said additional remote receiver.

13. The method according to claim 1, wherein said recorded content is stored on a secure storage.

14. The method according to claim 1, wherein access to stored content is regulated by a digital rights management system.

15. A device for making pre-scheduled recordings of broadcasted content, comprising:
a recording unit (2, 3) for receiving broadcasted content, and storing it on a storage medium (10),
input means (7) for allowing a user to schedule a recording and privacy setting for said recording,
a control unit (8) being adapted to determine that said scheduled recording conflicts with a previously scheduled recording,
further comprising:
means (9) for communicating a request to a remote receiver (101) to record content according to the scheduled recording that is found to be in conflict with previously scheduled recordings,
means (9, 3) for receiving said recorded content from said at least one recording device, and storing it on said storage medium (10), with access rights based on said privacy setting.

16. The device according to claim 15, further comprising means (12) for establishing contact with a personal security device for allowing a user to authenticate to said recording device.

17. The device according to claim 15, wherein said storage is a secure storage.

18. The device according to claim 15, wherein access to stored content is regulated by a digital rights management system.

19. The device according to claim 15, wherein said communicating means (9) are further adapted to receive a message from said remote receiver (101) indicating that a conflict has occurred with said recording request, and, in response to said message, to communicate a request to an additional remote receiver to record said content.

20. The device according to claim 15, wherein said communicating means (9) are further adapted to receive a message from said remote receiver (101) indicating that said recording request has been relayed to an additional remote receiver (102), and to receive said content from said additional remote receiver.

21. A computer program product, comprising computer code portions for performing the steps of the method according to claim 1 when said program product is executed on a computer.

22. The computer program product according to claim 21, stored on a computer readable medium.
